(19) United States
(12) Patent Application Publication
(10) Pub. No.: US 2026/0104145 A1
(43) Pub. Date: Apr. 16, 2026

(54) AUTOMATED DETERMINATION OF SAMPLING AND TEMPERATURE MEASUREMENT POINTS OF HYDROCARBON LIQUID IN A STORAGE TANK

(71) Applicant: Chevron U.S.A. Inc., San Ramon, CA (US)

(72) Inventor: Ochuko OFOYELA, Midland, TX (US)

(21) Appl. No.: 18/912,457

(22) Filed: Oct. 10, 2024

(51) Int. Cl. F17C 13/02

(52) U.S. Cl. CPC F17C 13/026; F17C 2250/032; F17C 2250/0408; F17C 2250/0439

(57) ABSTRACT

A measurement information system can include a controller configured to obtain identification information about a storage tank. The controller can also be configured to obtain a liquid level of a hydrocarbon liquid in the storage tank. The controller can further be configured to select a model from among a plurality of models associated with the storage tank based on the identification information. The controller can also be configured to run the model using the liquid level in the storage tank. The controller can further be configured to output a testing protocol for the storage tank based on results from running the model, where the testing protocol comprises one or more dip points, and where the one or more dip points designate one or more locations in the storage tank from which to take one or more temperatures and/or one or more sample measurements of the hydrocarbon liquid.

### TECHNICAL FIELD

The present application is related to sampling and temperature taking of hydrocarbon liquid in storage tanks and, more particularly, to automated determination of sampling and temperature measurement points for various depths of hydrocarbon liquid in a storage, lease, ship, barge, and/or other types of tanks.

### BACKGROUND

Storage tanks that hold oil and other hydrocarbon liquids are subject to certain standards and regulations. For example, a person is required to collect samples and measure temperatures at particular points in the storage tank. Regulations and standards dictate that the locations of these points may vary based on, for example, the capacity of the tank and the volume of liquid in the tank. This manual process can be time consuming and subject to frequent errors, particularly when multiple tanks are involved at a location. Existing solutions rely on manual calculations or personal judgement, which can lead to inconsistent and non-representative measurements.

### SUMMARY

In general, in one aspect, the disclosure relates to a measurement information system that includes a controller that is configured to obtain identification information about a storage tank. The controller of the measurement information system may also be configured to obtain a liquid level of a hydrocarbon liquid in the storage tank. The controller of the measurement information system may further be configured to select a model from among a plurality of models associated with the storage tank based on the identification information. The controller of the measurement information system may also be configured to run the model using the liquid level in the storage tank. The controller of the measurement information system may further be configured to output a testing protocol for the storage tank based on results from running the model, where the testing protocol comprises one or more dip points, and where the one or more dip points designate one or more locations in the storage tank from which to take one or more temperatures and/or one or more sample measurements of the hydrocarbon liquid.

In another aspect, the disclosure relates to a method for generating a testing protocol. The method may include obtaining identification information about a storage tank. The method may also include obtaining a liquid level of a hydrocarbon liquid in the storage tank. The method may further include selecting a model from among a plurality of models associated with the storage tank based on the identification information. The method may also include running the model using the liquid level in the storage tank. The method may further include outputting a testing protocol for the storage tank based on results from running the model, where the testing protocol comprises one or more dip points, and where the one or more dip points designate one or more locations in the storage tank from which to take one or more temperatures and/or one or more sample measurements of the hydrocarbon liquid.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIGS. 1A and 1B show various views of a storage system that includes a storage tank filled with hydrocarbon liquid that is subject to sampling and temperature measurement using certain example embodiments.

FIGS. 2A and 2B show various views of another storage system that includes a storage tank filled with hydrocarbon liquid that is subject to sampling and temperature measurement using certain example embodiments.

FIG. 3 shows a block diagram of an embodiment of a system according to certain example embodiments.

FIG. 3 shows a block diagram of a system that includes an example measurement information system according to certain example embodiments.

FIG. 4 shows an example of three dip points in a hydrocarbon liquid in a storage tank in accordance with certain example embodiments.

FIG. 5 shows an example of an output screen presented by a controller of the measurement information system according to certain example embodiments.

FIG. 6 shows a table outlining a minimum number of temperature readings and/or samples are required for various depths of hydrocarbon liquid within a storage tank based on certain industry standards according to with certain example embodiments.

FIG. 7 shows a table used by a controller of the measurement information system to select a unit of measurement (UOM) model and generate a testing protocol according to certain example embodiments.

FIGS. 8 through 10 show examples of output screens of a testing protocol with feet as the UOM, generated by the measurement information system for a storage tank according to certain example embodiments.

FIGS. 11 through 13 show examples of output screens of a testing protocol with inches as the UOM, generated by the measurement information system for another storage tank according to certain example embodiments.

FIGS. 14 through 16 show examples of output screens of a testing protocol with meters as the UOM, generated by the measurement information system for yet another storage tank according to certain example embodiments.

FIG. 17 shows a flowchart of a method for generating a testing protocol according to certain example embodiments.

FIG. 18 shows a block diagram of a computing device according to with certain example embodiments.

### DETAILED DESCRIPTION

The example embodiments discussed herein are directed to systems, apparatus, methods, and devices for automated determination of sampling and temperature measurement points of hydrocarbon liquid in a storage tank. Example embodiments may be used for automated determination of sampling and temperature measurement points of any type of hydrocarbon liquid (e.g., fuel oil, gasoline, crude oil) in any type and/or size of storage tank with uniform cross sectional area in any type of environment (e.g., buried, above ground, on a ship at sea).

As defined herein, as known by those of ordinary skill in the art, a dip point is a location (e.g., a depth) within the hydrocarbon liquid contained in a storage tank at which a temperature reading and/or a sample of the hydrocarbon liquid is collected so that one or more measurements can be made of the sample. Also as defined herein, a storage tank (also sometimes referred to herein more simply as a tank) is any type of vessel or storage container that holds or contains a hydrocarbon liquid. Examples of a storage tank includes, but are not limited to, a container ship, a barge, an above ground metal container, an above ground plastic container, a concrete cistern, and a buried underground metal tank.

Example embodiments provide for accurate sampling and temperature readings of a hydrocarbon liquid within a storage tank. This allows for a more accurate assessment of the quality and quantity of the hydrocarbon liquid. Example embodiments eliminate guesswork, enhance accuracy and efficiency, reduce the time needed to determine the correct dip points, and avoid confusion when a facility has multiple storage tanks with hydrocarbon liquids that require sampling and/or temperature measurements. Example embodiments incorporate the height of each storage tank, preconfigured based on strapping and/or calibration tables of each storage tank. The fluid level within a storage tank may be provided (e.g., by a user, by a sensor device), and this information is used by example embodiments to generate a testing protocol.

Example embodiments of measurement information systems can be designed to comply with certain standards and/or requirements. Examples of entities that set such standards and/or requirements can include, but are not limited to, the Society of Petroleum Engineers, the American Petroleum Institute (API), the International Standards Organization (ISO), and the Occupational Safety and Health Administration (OSHA). Also, as discussed above, example embodiments for measurement information systems may be used in marine, non-corrosive, and/or non-pressurized environments, and so example embodiments for measurement information systems may be designed to comply with industry standards that apply to marine, non-corrosive, and/or non-pressurized environments.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components.

For example, in some embodiments, the item described could include only a component of type A. In some embodiments, the item described could include only a component of type B. In some embodiments, the item described could include only a component of type C. In some embodiments, the item described could include a component of type A and a component of type B. In some embodiments, the item described could include a component of type A and a component of type C. In some embodiments, the item described could include a component of type B and a component of type C. In some embodiments, the item described could include a component of type A, a component of type B, and a component of type C.

In some embodiments, the item described could include two or more components of type A (e.g., A1 and A2). In some embodiments, the item described could include two or more components of type B (e.g., B1 and B2). In some embodiments, the item described could include two or more components of type C (e.g., C1 and C2). In some embodiments, the item described could include two or more of a first component (e.g., two or more components of type A (A1 and A2)), optionally one or more of a second component (e.g., optionally one or more components of type B), and optionally one or more of a third component (e.g., optionally one or more components of type C).

In some embodiments, the item described could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure may be inferred to that component. Conversely, if a component in a figure is labeled but not described, the description for such component may be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of automated determination of sampling and temperature measurement points of hydrocarbon liquid in a storage tank will be described more fully hereinafter with reference to the accompanying drawings, in which example embodiments of automated determination of sampling and temperature measurement points of hydrocarbon liquid in a storage tank are shown. Automated determination of sampling and temperature measurement points of hydrocarbon liquid in a storage tank may, however, be embodied in many different forms and should not be construed as limited to the example embodiments set forth herein. Rather, these example embodiments are provided so that this disclosure will be thorough and complete, and will fully convey the scope of automated determination of sampling and temperature measurement points of hydrocarbon liquid in a storage tank to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of automated determination of sampling and temperature measurement points of hydrocarbon liquid in a storage tank. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

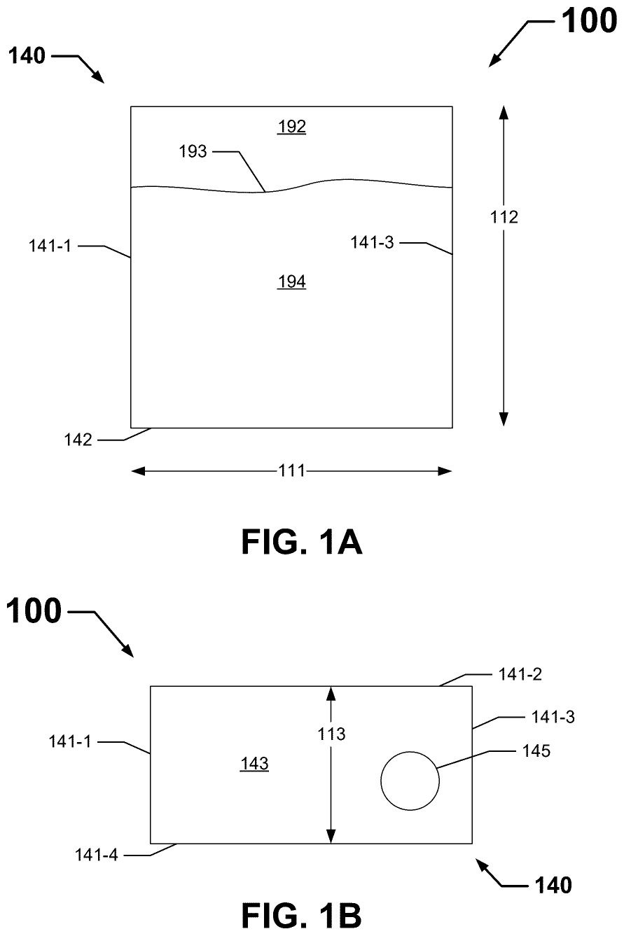

FIGS. 1A and 1B show various views of a storage system 100 that includes a storage tank 140 filled with hydrocarbon liquid 194 that is subject to sampling and temperature measurement using certain example embodiments. Specifically, FIG. 1A shows a sectional side view of the storage system 100, and FIG. 1B shows a top view of the storage system 100. The storage tank 140 of the storage system 100 of FIGS. 1A and 1B is a three-dimensional structure that includes one or more walls. In this case, the walls of the storage tank 140 form a three-dimensional rectangle having a height 112, a width 111, and a length 113. Specifically, the storage tank 140 has four side walls 141 (side wall 141-1, side wall 141-2, side wall 141-3, and side wall 141-4), a bottom wall 142, and a top wall 143.

In alternative embodiments, when the storage tank 140 has a different three-dimensional shape, the storage tank 140 may have more or fewer walls than what is shown in FIGS. 1A and 1B. For example, if the storage tank 140 is in the form of a sphere, the storage tank 140 may have only one wall. The storage tank 140 may be made of one or more of a number of materials, including but not limited to stainless steel, mild steel, aluminum, fiberglass, and concrete. In some cases, a coating or liner may be disposed along some or all of the inner surfaces of the walls of the storage tank 140.

The storage tank 140 may include one or more access points 145. Each access point 145 of the storage tank 140 allows a user to put an object (e.g., a sample collector, a sensor device, a level gauge tape/bob, portable electronic gauging tape) inside of the storage tank 140. In this case, there is one access point 145 in the form of a door hatch in the top wall 143. In certain example embodiments, at least one of the access points 145 of the storage tank 140 is located in the headspace 192 above the liquid level 193 of the liquid 194 within the storage tank 140. The liquid 194 can be or include any type of hydrocarbon liquid. For example, the liquid 194 may be or include a hydrocarbon liquid (e.g., crude oil, fuel oil, gasoline, diesel fuel, kerosene jet fuel).

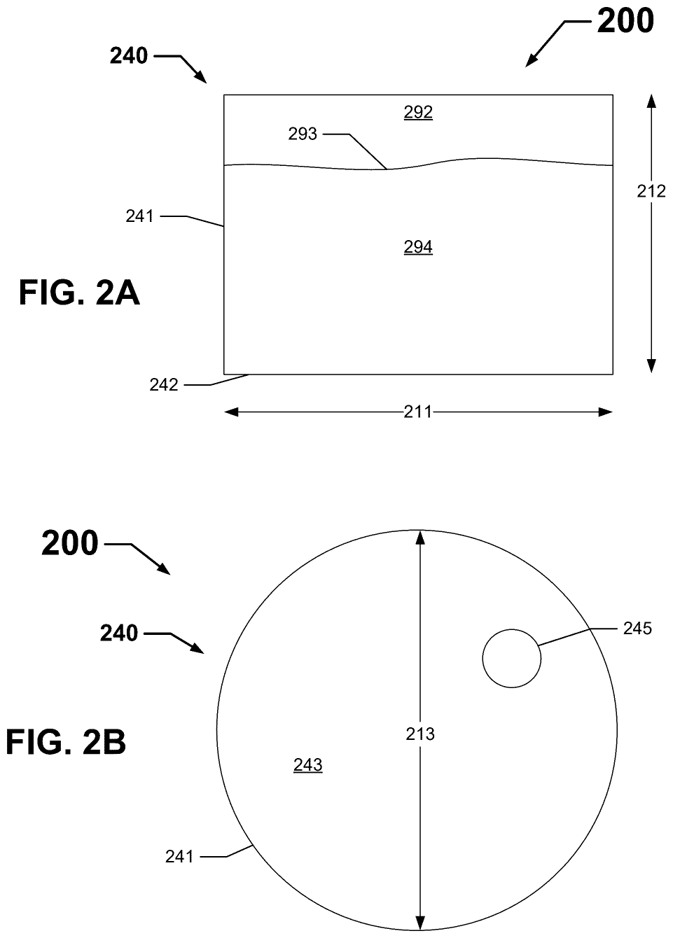

FIGS. 2A and 2B show various views of another storage system 200 that includes a storage tank 240 filled with hydrocarbon liquid 294 that is subject to sampling and temperature measurement using certain example embodiments. Specifically, FIG. 2A shows a sectional side view of the storage system 200, and FIG. 2B shows a top view of the storage system 200. Referring to the description above with respect to FIGS. 1A and 1B, the storage tank 240 of the storage system 200 of FIGS. 2A and 2B has a cylindrical shape that includes one side wall 241, a bottom wall 242, and a top wall 243. The storage tank 240 has a height 212, a width 211, and a length 213 that substantially equals the width 211.

Some characteristics of the storage tank 240 of FIGS. 2A and 2B are substantially the same as the corresponding characteristics of the storage tank 140 of FIGS. 1A and 1B. For example, the storage tank 240 may be made of one or more of a number of materials, including but not limited to stainless steel, plastic, a polymer, glass, and a ceramic. In some cases, a coating or liner may be disposed along some or all of the inner surfaces of the walls of the storage tank 240. Also, the storage tank 240 in this case has one access point 245 in the form of a door hatch in the top wall 243. The access point 245 of the storage tank 240 is located in the headspace 292 above the liquid level 293 of the liquid 294 within the storage tank 240. The liquid 294 can be or include any type of hydrocarbon liquid. For example, the liquid 294 may be or include crude oil, fuel oil, gasoline, diesel fuel, and kerosene jet fuel..

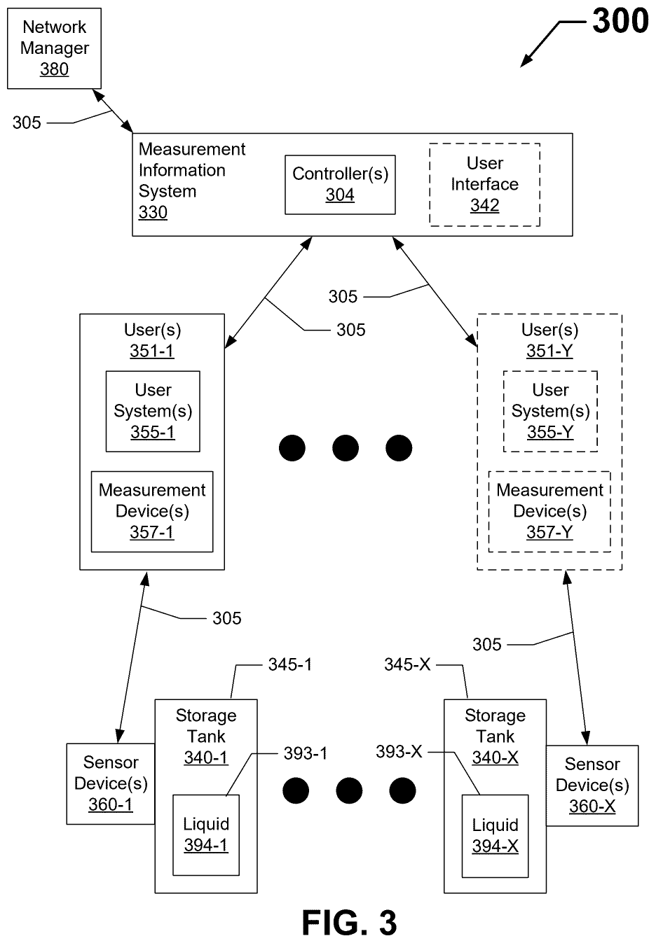

FIG. 3 shows a block diagram of a system 300 that includes an example measurement information system 130 according to certain example embodiments. Referring to the description above with respect to FIGS. 1A through 2B, the system 300 of FIG. 3 includes one or more storage tanks 340, one or more users 351, one or more sensor devices 360, a network manager 380, and an example measurement information system 330. Each user 351 includes one or more user systems 355 and one or more measurement devices 357. The example measurement information system 330 includes one or more controllers 304 and one or more optional user interfaces 342.

The components shown in FIG. 3 are not exhaustive, and in some embodiments, one or more of the components shown in FIG. 3 may not be included in the example system 300. Any component of the system 300 may be discrete or combined with one or more other components of the system 300. Also, one or more components of the system 300 may have different configurations. For example, one or more of the sensor devices 360 may be integrated with a storage tank 340 rather than being a separate component coupled to or placed in proximity to a storage tank 340. As another example, some or all of a controller 304 may be distributed over multiple locations rather than being a stand-alone device contained within a housing of the measurement information system 330.

Each of these components of the system 300 may transmit communication signals to each other using one or more communication links 305, described below. Specifically, communication between the network manager 380, the users 351 (including any associated user systems 355 and/or measurement devices 357), the controllers 304, the sensor devices 360, and any other components of the system 300 may be facilitated using the communication links 305. Each communication link 305 may include wired (e.g., Class 1 electrical cables, electrical connectors, Power Line Carrier) and/or wireless (e.g., sound or pressure waves in the liquid 394, Wi-Fi, Zigbee, visible light communication, cellular networking, Bluetooth, Bluetooth Low Energy (BLE), ultrawide band (UWB), Wireless HART, ISA100) technology.

A user 351 may be any person or entity that interacts, directly or indirectly, with one or more other components (e.g., the measurement information system 330, a storage tank 340, a sensor device 360) of the system 300. Examples of a user 351 may include, but are not limited to, a business owner, an engineer, a company representative, an operator, a technician, a regulator, an inspector, a consultant, a contractor, a regulator, a regulatory agency, an government representative, a government agency, a manufacturer, and a manufacturer's representative. The system 300 may have a single user 351 or multiple (e.g., 2, 4, 7, 10, 50, 100, 800, 1500) users 351. In this case, there are Y users 351 (user 351-1 through user 351-Y).

A user 351 may use one or more user systems 355, which may include a display (e.g., a GUI). In this case, user 351-1 has user system 355-1, and user 351-Y has user system 355-Y. A user system 355 of a user 351 may interact with (e.g., send data to, obtain data from) the example measurement information system 330 (or portion thereof, such as a controller 304), the network manager 380, the sensor devices 360, and/or any other component of the system 300 via an application interface and using the communication links 305. The user 351 (including an associated user system 355) may also interact directly with the example measurement information system 330 (including portions thereof, such as one or more of the controllers 304), the network manager 380, one or more of the sensor devices 360, and/or any other component of the system 300 through a user interface (e.g., a probe, an electrical connector, keyboard, mouse, touchscreen).

A user system 355 of a user 351 interacts with (e.g., sends data to, receives data from) the example measurement information system 330 via an application interface. Examples of a user system 355 may include, but are not limited to, a cell phone with an app, a laptop computer, a dedicated handheld device, a smart watch, a desktop computer, and an electronic tablet. In some cases, a user 351 (including an associated user system 355) may also interact directly with the network manager 380, one or more of the controllers 304 of the example measurement information system 330, one or more of the sensor devices 360, and/or any other components in the system 300 using one or more communication links 305.

Each user 351 may have one or more measurement devices 357. In this case, user 351-1 has measurement device 357-1, and user 351-Y has measurement device 357-Y. A measurement device 357 is an instrument that a user 351 puts into a storage tank 340, for example, to measure a parameter (e.g., a liquid level) associated with the storage tank 340 and/or to measure a parameter (e.g., a temperature) associated with the liquid 394 in the storage tank 340.

A measurement device 357 may have any of a number of configurations and include any of a number of components. For example, a measurement device 357 may be a length (e.g., 10 feet, 25 feet, 50 feet) of rope or cable, toward the end of which is a sensor device (e.g., similar to a sensor device 360 discussed below (e.g., servo-operated float gauges, mechanical float & tape tank gauge, float-operated (automatic) tank gauges (FTG), guided wave radar) or a sample collection mechanism (e.g., a process line from the storage tank that can be opened and closed on demand to allow for the inflow of the liquid 394 i.e. collected via an automatic sampling system in the process line). In addition, or in the alternative, a measurement device 357 may include a depth gauge to indicate how far down a certain part (e.g., a sensor device, a sample collection mechanism) of the measurement device 357 is located relative to another part (e.g., where the rope or cable breaks the liquid level 393) of the measurement device 357 in the storage tank 340. In addition, or in the alternative, a measurement device 357 may be non-invasive (e.g., a radar level sensor, a magnetic level gauge).

A measurement device 357 may be a manufactured product and/or an apparatus that is created by a user 351. When a measurement device 357 includes a sensor device, the sensor device may have communication capabilities using the communication links 305. For example, a sensor device of a measurement device 357 may be configured to communicate with (e.g., send measurements to, receive instructions from) another sensor device 360, a controller 304 of the measurement information system 330, and/or some other component of the system 300. The various components of the measurement device 357 may be configured to be used over extended periods of time (e.g., days, weeks, months) and/or for frequent shorter periods of time (e.g., one minute, 5 minutes, 30 minutes, an hour) while submerged in various types of liquids 394 that are stored in the storage tanks 340. Use of the measurement device 357 in some cases may be non-invasive to the liquid 394 in a storage tank 340.

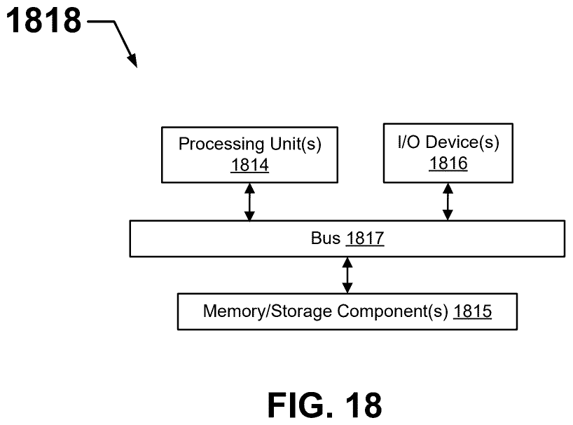

The network manager 380 is a device or component that controls all or a portion (e.g., a communication network, a controller 304 of the example measurement information system 330) of the system 300. The network manager 380 may be substantially similar to a controller 304 of the example measurement information system 330, discussed below. For example, the network manager 380 may include a controller that has one or more components and/or similar functionality to some or all of the controller 304 of the measurement information system 330. Alternatively, the network manager 380 may include one or more of a number of features in addition to, or altered from, the features of the controller 304 of the measurement information system 330. As described herein, control and/or communication with the network manager 380 may include communicating with one or more other components of the same system 300 or another system. In such a case, the network manager 380 may facilitate such control and/or communication. The network manager 380 may be called by other names, including but not limited to a master controller, a network controller, and an enterprise manager. The network manager 380 may be considered a type of computer device, as discussed below with respect to FIG. 18.

As discussed above, in some cases, one or more sensor devices 360 may be integrated with a measurement device 357. In such a case, the measurement device 357 may use a sensor device 360 to measure a parameter (e.g., a temperature) of a liquid 394 when the measurement device 357 is submerged in the liquid 394 within a storage tank 340 or measures the parameter of the liquid when the measurement device 357 is located outside the liquid 394 via a non-invasive method. In some cases, a number of sensor devices 360, each measuring a different parameter, may be used in combination to determine and confirm whether a controller 304 should take a particular action (e.g., run an algorithm, output a result). When a sensor device 360 includes its own controller (e.g., a controller 304), or portions thereof, then the sensor device 360 may be considered a type of computer device, as discussed below with respect to FIG. 18.

Each sensor device 360 includes one or more sensors that measure one or more parameters (e.g., temperature, humidity, pressure, voltage, a level (e.g., a depth), a volume of liquid 394, current, voltage differential, current differential, resistance, electrical continuity, presence of an object or component, chemical elements in a fluid). Examples of a sensor of a sensor device 360 may include, but are not limited to, a temperature sensor, a pressure sensor, a proximity sensor, a gas spectrometer, a vibration sensor, an accelerometer, a gyroscope, an infrared transceiver, a voltmeter, an ammeter, a load cell, a servo-operated float gauge, a mechanical float and tape tank gauge, a float-operated (automatic) tank gauge (FTG), a guided wave radar a radar level sensor, a magnetic level gauge, and a camera. A sensor device 360 may be integrated with or measure a parameter associated with one or more components of a storage tank 340 and/or the liquid 394 within a storage tank 340. For example, a sensor device 360 may be configured to measure the height and/or volume of a liquid 394 within a storage tank 340. As another example, a sensor device 360 may be configured to measure the temperature of a liquid 394 within a storage tank 340.

A sensor device 360 may be configured to communicate (e.g., send measurements to, receive instructions from) with one or more other components (e.g., a controller 304 of the measurement information system 330, a user system 355) of the system 300 using communication links 305. In such cases, the sensor device 360 may include at least some components similar to a controller 304, as discussed above. In such cases, the sensor device 360 may be considered a type of computer device, as discussed below with respect to FIG. 18.

The system 300 can have any number (e.g., 1, 2, 5, 18, 54, etc.) of storage tanks 340. In this case, the system 300 has X storage tanks 340 (storage tank 340-1 through storage tank 340-X). Each of the storage tanks 340 of FIG. 3 is substantially similar to the storage tanks discussed above with respect to FIGS. 1A through 2B. For example, a storage tank 340 may be or include, for example, a lease tank, a ship tank, or a barge tank. When the system 300 includes multiple storage tanks 340, the characteristics (e.g., shape, size, capacity, material, height, length, width) of one storage tank 340 may be the same as, or different than, the corresponding characteristics of one or more of the other storage tanks 340 in the system 300.

In this case, each storage tank 340 in the system 300 contains a liquid 394, which is substantially similar to the liquids discussed above with respect to FIGS. 1A through 2B. In some cases, each storage tank 340 may contain a different liquid 394. In alternative cases, two or more storage tanks 340 may contain the same liquid 394. In this example, there are X liquids 394 (liquid 394-1 through liquid 394-X), which means that there is a different liquid 394 contained by each storage tank 340 in the system 300. There is a liquid level 393 of liquid 394 in each storage tank 340. For example, there is a liquid level 393-1 of the liquid 394-1 in storage tank 340-1, and there is a liquid level 393-X of the liquid 394-X in storage tank 340-X. The amount of liquid 394 in each storage tank 340 may vary. In addition, each storage tank 340 includes at least one access point 345 (access point 345-1 for storage tank 340-1, access point 345-X for storage tank 340-X) to allow access to the liquid 394 by a user 351 (including an associated measurement device 357).

Each storage tank 340 in the system 300 has identification information. Examples of identification information may include, but is not limited to, an identification number (e.g., internally assigned by an owner (e.g., a type of user 351) of the storage tank 340), a serial number, a make/model number, a maximum capacity, a shape, a height, a width, a length, the material, the location of access point(s) 345, and the number of access points 345. The identification information of a storage tank 340 may be independent of the liquid 394 that is contained within the storage tank 340 at any point in time. In other words, the identification information is related to the storage tank 340 itself rather than the contents within the storage tank 340.

As mentioned above, the measurement information system 330 may include one or more controllers 304. Each controller 304 may be communicably coupled to the network manager 380, one or more of the users 351 (including associated user systems 355 and/or measurement devices 357), and one or more of the sensor devices 360. A controller 304 may perform a number of functions that may include obtaining and sending data, evaluating data, following protocols, running algorithms, and sending commands. A controller 304 of FIG. 3 may include one or more of a number of components. For example, components of a controller 304 may include, but are not limited to, a control engine, a communication module, a timer, a counter, a power module, a storage repository, a hardware processor, memory, a transceiver, an application interface, and a security module.

When there are multiple controllers 304 (e.g., one controller 304 for the example measurement information system 330, another controller 304 for a sensor device 360, yet another controller for a user system 355), each controller 304 may operate independently of each other. Alternatively, one or more of the controllers 304 may work cooperatively with each other. As yet another alternative, one of the controllers 304 may control some or all of one or more other controllers 304 in the system 300. As still another alternative, one or more of the controllers 304 may be in communication with and controlled by a controller of the example measurement information system 330. Each controller 304 may be considered a type of computer device, as discussed below with respect to FIG. 18.

In certain example embodiments, the measurement information system 330 may include one or more optional user interface 342. Examples of a user interface 342 may include, but are not limited to, a keyboard, a cursor control device (e.g., a mouse), a microphone, a touchscreen, a scanner (e.g., for fingerprints, for documents), a display device (e.g., a monitor or projector), speakers, a printer, and a network card. When the measurement information system 330 includes a user interface 342, a controller 304 may be communicably coupled to the user interface 342 using communication links 305 internal to the measurement information system 330.

A controller 304 of the example measurement information system is configured to provide a testing protocol for a storage tank 340. The testing protocol may include information such as a number of dip points from which samples and/or temperature measurements in the liquid 394 in a storage tank 340 are to be taken (e.g., by a user 351, determined using a measurement device 357) and exact depth (e.g., from an access point 345 of the storage tank 340, based on the liquid level 393) in the storage tank 340) of each dip point.

The testing protocol for a particular storage tank 340 helps ensure that a user 351 is following applicable requirements (e.g., regulatory standards, industry standards, statutory) that apply to the sampling and measurement of the liquid 394 (e.g., non-pressurized hydrocarbon liquid) contained within a tank 340. For example, the testing protocol output by the controller 304 of the measurement information system 330 may specify a minimum number and corresponding location of temperature measurements needed and/or a minimum number and corresponding location of sample measurements needed for a storage tank 340 based, at least in part, on the amount (e.g., the depth) of liquid 394 in the storage tank 340.

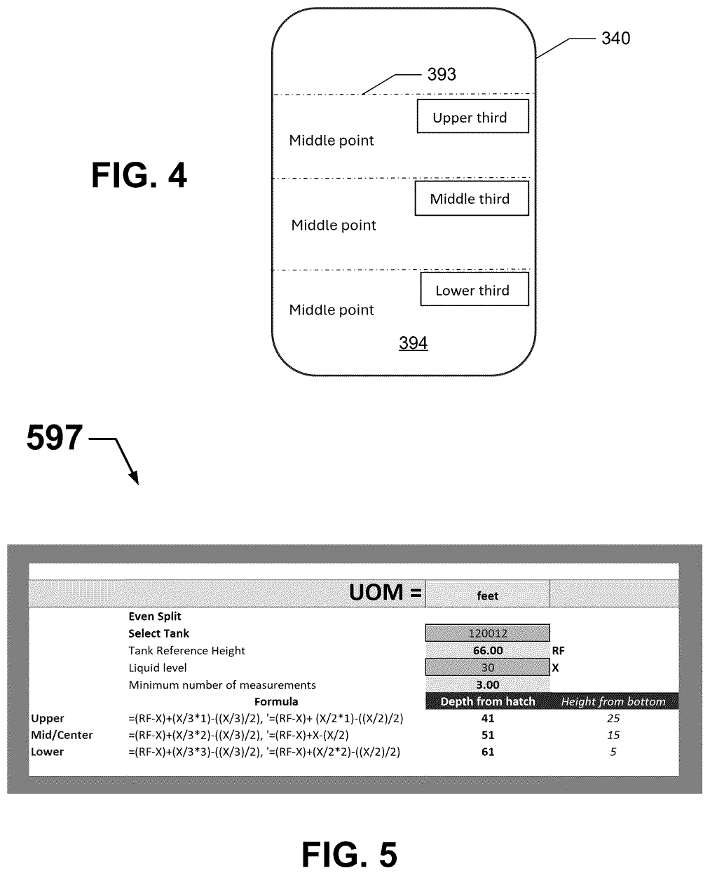

For example, according to one or more existing standards, regulations, statutes, and/or other requirements, a storage tank 340 that contains at least 6 meters (approximately 20 feet) of liquid 394 must have three temperature measurements and/or sample measurements taken of the liquid 394, where one temperature measurement and/or sample measurement is taken at the middle point of the lower third of the liquid level 393 in the storage tank 340, where another temperature measurement and/or sample measurement is taken at the middle point of the middle third of the liquid level 393 in the storage tank 340, and where another temperature measurement and/or sample measurement is taken at the middle point of the upper third of the liquid level 393 in the storage tank 340. An example of this is shown in FIG. 4.

As another example, according to one or more existing standards, regulations, statutes, and/or other requirements, a storage tank 340 that contains at least 3 meters (approximately 10 feet) but less than 6 meters (approximately 20 feet) of liquid 394 must have two temperature measurements and/or sample measurement taken of the liquid 394, where one temperature measurement and/or sample measurement is taken at the middle point of the lower half of the liquid level 393 in the storage tank 340, and where the other temperature measurement and/or sample measurement is taken at the middle point of the upper half of the liquid level in the storage tank 340. As yet another example, according to one or more existing standards, regulations, statutes, and/or other requirements, a storage tank 340 that contains less than 3 meters (approximately 10 feet) of liquid 394 must have one temperature measurement and/or sample measurement taken of the liquid 394, where the temperature measurement and/or sample measurement is taken at the middle point of the liquid level 393 in the storage tank 340.

A controller 304 of the measurement information system 330 may include a conversion table that enables the controller 304 to work with any unit of measure (e.g., liters versus gallons, feet versus meters, ° F. versus ° C.) that is used and/or required under the circumstances. In order to provide a testing protocol for a particular storage tank 340 a controller 304 of the measurement information system 330 uses various information. For example, a controller 304 of the measurement information system 330 may obtain some or all of the identification information for each storage tank 340. Once obtained, the controller 304 of the measurement information system 330 may generate and maintain a database or series of tables of the identification information for each of the storage tanks 340.

The identification information of each storage tank 340 may be obtained by the controller 304 from one or more of the sensor devices 360, from one or more of the users 351 (including any associated user systems 355), from the network manager 380, and/or from any other source having such identification information. As used herein, the term “obtain” or “obtaining” may include collecting, receiving, retrieving, accessing, generating, etc. or any other manner of obtaining something (in this case, identification information for the storage tanks 340) from one or more sources.

Another example of information used by a controller 304 of the measurement information system 330 to provide a testing protocol for a liquid 394 in a storage tank 340 is the various laws, rules, and/or regulations that may apply to testing the liquid 394 in the storage tank 340. The potentially applicable laws, rules, and/or regulations may be obtained by the controller 304 from one or more of the users 351 (including any associated user systems 355), from the network manager 380, and/or from any other source having such identification information.

Yet another example of information used by a controller 304 of the measurement information system 330 to provide a testing protocol for a liquid 394 in a storage tank 340 is a location of the storage tank 340. The location of a storage tank 340 may indicate which laws, rules, and/or regulations apply to testing the liquid 394 in the storage tank 340. The location of a storage tank 340 may be obtained by the controller 304 from one or more of the sensor devices 360 (e.g., a GPS device), from one or more of the users 351 (including any associated user systems 355), from the network manager 380, and/or from any other source having such identification information.

Still another example of information used by a controller 304 of the measurement information system 330 to provide a testing protocol for a liquid 394 in a storage tank 340 is the chemical content of the liquid 394 in the storage tank 340. The chemical content of the liquid 394 may indicate which laws, rules, and/or regulations apply to testing the liquid 394 in the storage tank 340. The location of a storage tank 340 may be obtained by the controller 304 from one or more of the sensor devices 360 (e.g., a liquid analyzer), from one or more of the users 351 (including any associated user systems 355), from the network manager 380, and/or from any other source having such identification information.

Yet another example of information used by a controller 304 of the measurement information system 330 to provide a testing protocol for a liquid 394 in a storage tank 340 is the liquid level 393 of the liquid 394 in the storage tank 340. The liquid level 393 of the liquid 394 in the storage tank 340 may indicate which laws, rules, and/or regulations apply to testing the liquid 394 in the storage tank 340. The liquid level 393 of the liquid 394 in the storage tank 340 may be obtained by the controller 304 from one or more of the sensor devices 360 (e.g., a level detector), from one or more of the users 351 (including any associated user systems 355), from the network manager 380, and/or from any other source having such identification information.

When a controller 304 of the measurement information system 330 obtains sufficient information, the controller 304 may select an appropriate model for the liquid 394 and/or the storage tank 340, run the model using at least some of the information (e.g., the liquid level 393 of the liquid 394 in the storage tank 340 obtained using a measurement device 357), and generate a testing protocol. Once generated, the testing protocol may be followed by a user 351 (e.g., using another measurement device 357) to measure the temperature and/or collect samples of the liquid 394 at the proper locations (also called dip points herein) within the storage tank 340 to comply with applicable rules, laws, and/or regulations. In some cases, the controller 304 may update a model based on, for example, input from a user 351, updates from the network manager 380, and/or actual results compared to prior testing protocols.

The output of the measurement information system 330 is generated by a controller 304. The output of the measurement information system 330 may take one or more of any of a number of forms that are suitable for a user 351. Examples of the output of the measurement information system 330 may include, but are not limited to, a text message, an email, a display on a screen, an electronic document, an audio file, and telephone call. A controller 304 of the measurement information system 330 may provide the output directly to one or more users 351 (including associated user systems 355) and/or on the user interface 342 of the measurement information system 330.

The output of the measurement information system 330 may be used by a user 351, for example, when the user 351 is an operation personnel who would otherwise manually calculate measurement points within the liquid 394 in a storage tank 340, as in the current art. In such a case, without the output of the measurement information system 330, a user 351 tends to make arbitrary determinations and/or inaccurate conclusions, which leads to a lack of compliance with applicable rules, regulations, standards, and/or laws. By contrast, using the output of the measurement information system 330, a user 351 is ensured of the one or more depths of the liquid 394 within a storage tank 340 from which to measure temperatures and/or collect samples.

FIG. 5 shows an example of an output screen 597 presented by a controller 304 of the measurement information system 330 according to certain example embodiments. Referring to the description above with respect to FIGS. 1A through 4, the output screen 597 of FIG. 5 shows that identification information of a storage tank 340 has been obtained (e.g., by a user 351). Specifically, the output screen 597 shows that identification information in the form of an internal identification number (in this case, 120012) of the storage tank 340 has been obtained, resulting in other associated information about the storage tank 340 (e.g., the reference height 212) to be retrieved from a table (e.g., as shown in FIG. 7 below) generated and maintained by a controller 304 of the measurement information system 330.

In addition, the output screen 597 of FIG. 5 shows that the liquid level 393 (in this case, 30 feet) of the storage tank 340 has been obtained. The liquid level 393 may be obtained from a sensor device 360 obtained by measurement device 357 and/or a user 351. With the identification information of the storage tank 340 and the liquid level 393 of the storage tank 340 and the UOM selected, a controller 304 of the measurement information system 330 may select a model based on the identification information of the storage tank 340 and run the model using the liquid level 393 obtained by measurement device 357 of the storage tank 340 to generate a testing protocol, as shown in the output screen 597. In this case, the testing protocol specifies that 3 measurements are to be taken (e.g., by a user 351 using a manual measurement device), with one measurement to be taken 61 feet from the access point 345 (e.g., hatch) (which is the same as 5 feet from the bottom of the storage tank 340), a second measurement to be taken 51 feet from the access point 345 (which is the same as 15 feet from the bottom of the storage tank 340), and a third measurement to be taken 41 feet from the access point 345 (which is the same as 25 feet from the bottom of the storage tank 340). The output screen 597 shows some of the formulas used in the model.

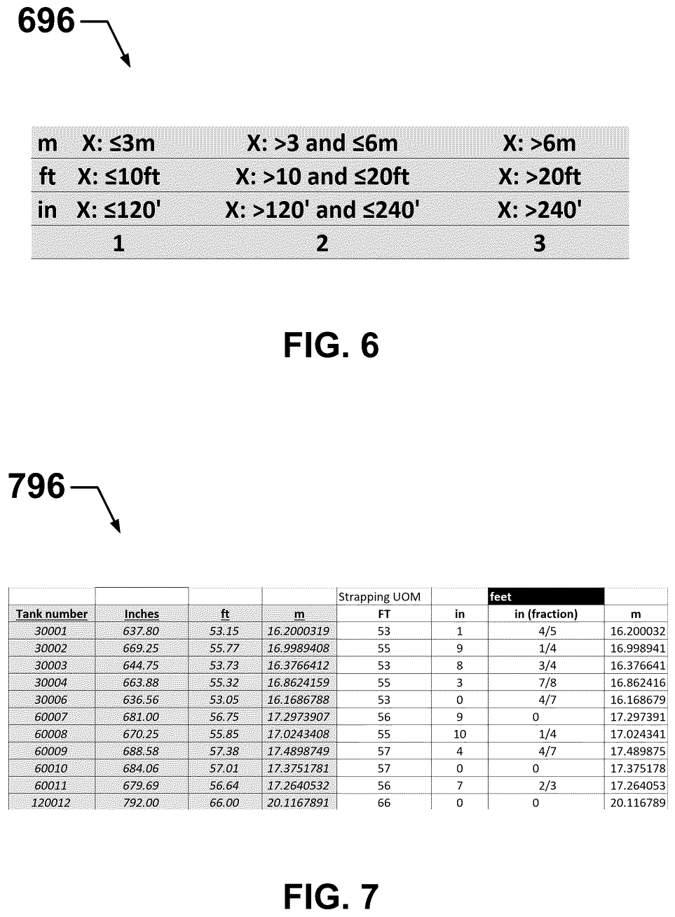

FIGS. 6 and 7 show tables used by a controller of the measurement information system to select a model and generate a testing protocol according to certain example embodiments. Referring to the description above with respect to FIGS. 1A through 5, the table 696 of FIG. 6 shows measurement ranges in three different units of measurement (specifically, meters, feet, and inches) for three different measurement zones for a particular storage tank 340 (e.g., the storage tank 340 identified in the output screen 597 of FIG. 5) based on a liquid level 393 that is high enough within the storage tank 340 to require three dipping points. The table 796 of FIG. 7 shows identification information for 11 different storage tanks 340. The table 796 is organized by internal identification number of the 11 storage tanks 340 and lists the height of each storage tank 340 in inches, feet, and meters. The table 796 also lists some calculations for converting units of measure for each storage tank 340.

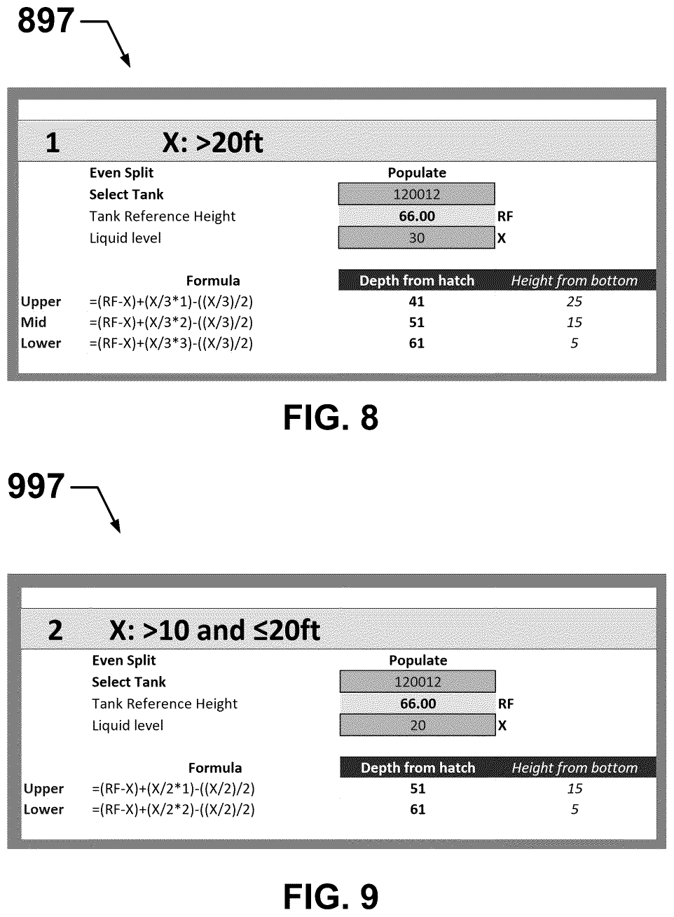

FIGS. 8 through 10 show examples of output screens of a testing protocol generated by the measurement information system 330 for a storage tank 340 according to certain example embodiments. All of the output screens of FIGS. 8 through 10 show the testing protocol in feet. Referring to the description above with respect to FIGS. 1A through 7, the output screen 897 of FIG. 8 shows that identification information of a storage tank 340 has been obtained (e.g., by a user 351). Specifically, the output screen 897 shows that identification information in the form of an internal identification number (in this case, 120012) of the storage tank 340 has been obtained, resulting in other associated information about the storage tank 340 (e.g., a height 212 of 66 feet) to be retrieved from a table generated and maintained by a controller 304 of the measurement information system 330.

In addition, the output screen 897 of FIG. 8 shows that the liquid level 393 (in this case, 30 feet) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 897.

In this case, the testing protocol specifies that 3 measurements are to be taken (e.g., by a user 351 using a manual measurement device), with one measurement to be taken 61 feet from the access point 345 (e.g., hatch) (which is the same as 5 feet from the bottom of the storage tank 340), a second measurement to be taken 51 feet from the access point 345 (which is the same as 15 feet from the bottom of the storage tank 340), and a third measurement to be taken 41 feet from the access point 345 (which is the same as 25 feet from the bottom of the storage tank 340). The output screen 897 shows some of the formulas used in the model.

The output screen 997 of FIG. 9 shows that identification information of a storage tank 340 has been obtained (e.g., by a user 351). Specifically, the output screen 997 shows that identification information in the form of an internal identification number (in this case, 120012) of the storage tank 340 has been obtained, resulting in other associated information about the storage tank 340 (e.g., a height 212 of 66 feet) to be retrieved from a table generated and maintained by a controller 304 of the measurement information system 330.

In addition, the output screen 997 of FIG. 9 shows that the liquid level 393 (in this case, 20 feet) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 997. In this case, the testing protocol specifies that 2 measurements are to be taken (e.g., by a user 351 using a manual measurement device), with one measurement to be taken 61 feet from the access point 345 (which is the same as 5 feet from the bottom of the storage tank 340), and the other measurement to be taken 51 feet from the access point 345 (which is the same as 15 feet from the bottom of the storage tank 340). The output screen 997 shows some of the formulas used in the model.

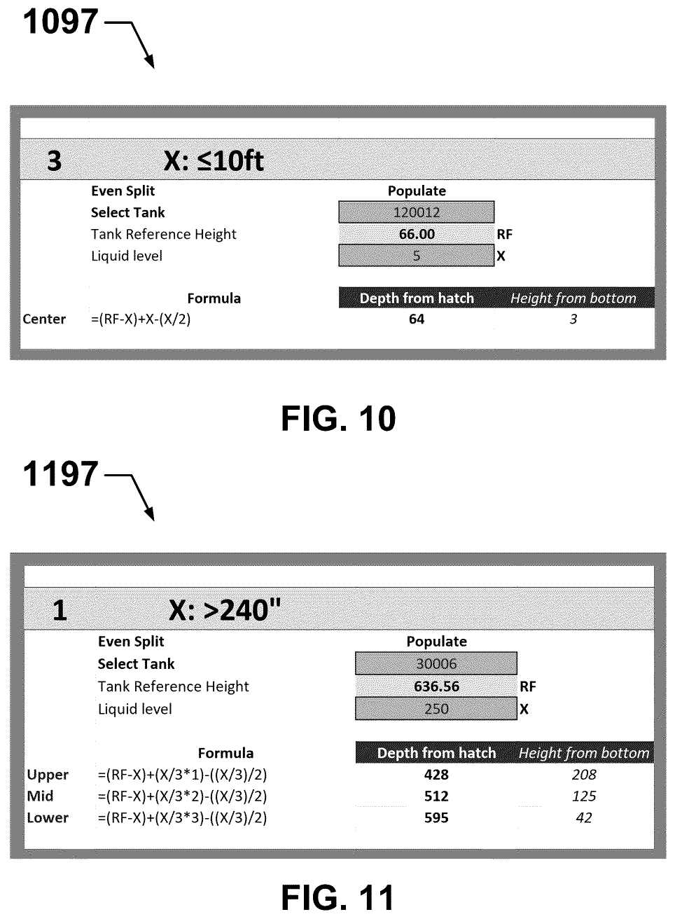

The output screen 1097 of FIG. 10 shows that identification information of a storage tank 340 has been obtained (e.g., by a user 351). Specifically, the output screen 997 shows that identification information in the form of an internal identification number (in this case, 120012) of the storage tank 340 has been obtained, resulting in other associated information about the storage tank 340 (e.g., a height 212 of 66 feet) to be retrieved from a table generated and maintained by a controller 304 of the measurement information system 330.

In addition, the output screen 1097 of FIG. 10 shows that the liquid level 393 (in this case, 5 feet) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 1097. In this case, the testing protocol specifies that only one measurement is to be taken (e.g., by a user 351 using a manual measurement device) 64 feet from the access point 345 (which is the same as 3 feet from the bottom of the storage tank 340). The output screen 1097 shows some of the formulas used in the model.

FIGS. 11 through 13 show examples of output screens of a testing protocol generated by the measurement information system 330 for another storage tank 340 according to certain example embodiments. All of the output screens of FIGS. 11 through 13 show the testing protocol in inches. Referring to the description above with respect to FIGS. 1A through 10, the output screen 1197 of FIG. 11 shows that identification information of a storage tank 340 has been obtained (e.g., by a user 351). Specifically, the output screen 1197 shows that identification information in the form of an internal identification number (in this case, 30006) of the storage tank 340 has been obtained, resulting in other associated information about the storage tank 340 (e.g., a height 212 of 636.56 inches) to be retrieved from a table generated and maintained by a controller 304 of the measurement information system 330.

In addition, the output screen 1197 of FIG. 11 shows that the liquid level 393 (in this case, 250 inches) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 1197.

In this case, the testing protocol specifies that 3 measurements are to be taken (e.g., by a user 351 using a manual measurement device), with one measurement to be taken 595 inches from the access point 345 (e.g., hatch) (which is the same as 42 inches from the bottom of the storage tank 340), a second measurement to be taken 512 inches from the access point 345 (which is the same as 125 inches from the bottom of the storage tank 340), and a third measurement to be taken 428 inches from the access point 345 (which is the same as 208 inches from the bottom of the storage tank 340). The output screen 1197 shows some of the formulas used in the model.

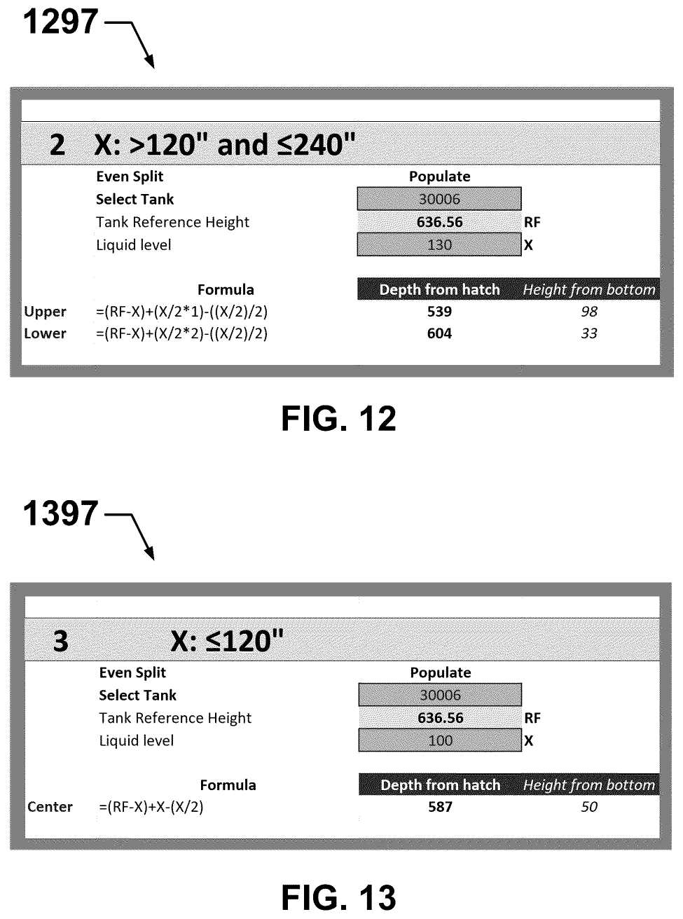

The output screen 1297 of FIG. 12 shows that identification information of a storage tank 340 has been obtained (e.g., by a user 351). Specifically, the output screen 1297 shows that identification information in the form of an internal identification number (in this case, 30006) of the storage tank 340 has been obtained, resulting in other associated information about the storage tank 340 (e.g., a height 212 of 636.56 inches) to be retrieved from a table generated and maintained by a controller 304 of the measurement information system 330.

In addition, the output screen 1297 of FIG. 12 shows that the liquid level 393 (in this case, 130 inches) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 1297. In this case, the testing protocol specifies that 2 measurements are to be taken (e.g., by a user 351 using a manual measurement device), with one measurement to be taken 604 inches from the access point 345 (which is the same as 33 inches from the bottom of the storage tank 340), and the other measurement to be taken 539 inches from the access point 345 (which is the same as 98 inches from the bottom of the storage tank 340). The output screen 1297 shows some of the formulas used in the model.

The output screen 1397 of FIG. 13 shows that identification information of a storage tank 340 has been obtained (e.g., by a user 351). Specifically, the output screen 1397 shows that identification information in the form of an internal identification number (in this case, 30006) of the storage tank 340 has been obtained, resulting in other associated information about the storage tank 340 (e.g., a height 212 of 636.56 inches) to be retrieved from a table generated and maintained by a controller 304 of the measurement information system 330.

In addition, the output screen 1397 of FIG. 13 shows that the liquid level 393 (in this case, 100 inches) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 1397. In this case, the testing protocol specifies that only one measurement is to be taken (e.g., by a user 351 using a manual measurement device) 587 inches from the access point 345 (which is the same as 50 inches from the bottom of the storage tank 340). The output screen 1397 shows some of the formulas used in the model.

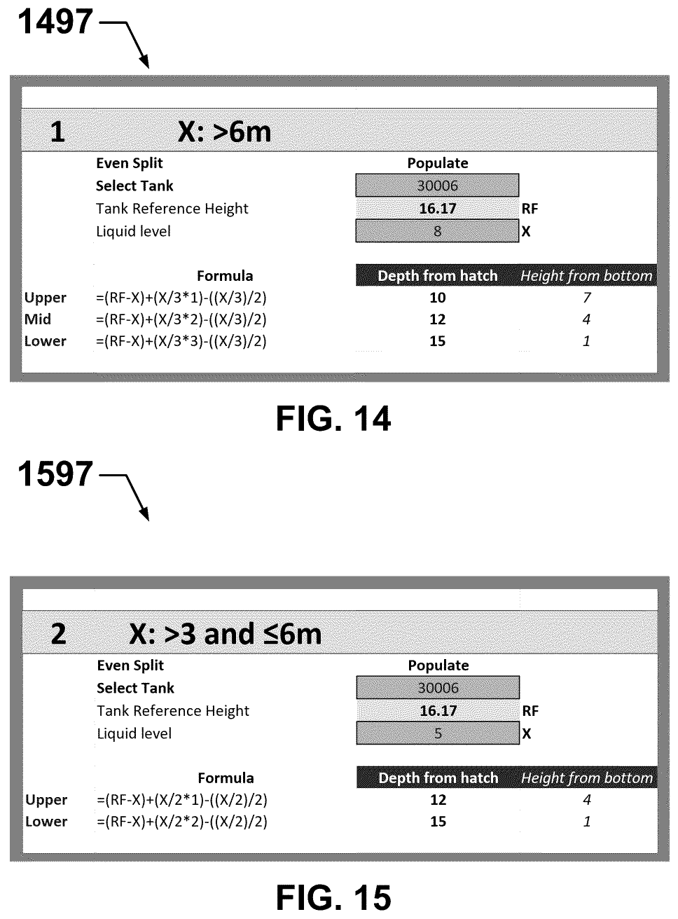

FIGS. 14 through 16 show examples of output screens of a testing protocol generated by the measurement information system for yet another storage tank according to certain example embodiments. All of the output screens of FIGS. 11 through 13 show the testing protocol in meters. Referring to the description above with respect to FIGS. 1A through 13, the output screen 1497 of FIG. 14 shows that identification information of a storage tank 340 has been obtained (e.g., by a user 351). Specifically, the output screen 1497 shows that identification information in the form of an internal identification number (in this case, 30007) of the storage tank 340 has been obtained, resulting in other associated information about the storage tank 340 (e.g., a height 212 of 16.17 meters) to be retrieved from a table generated and maintained by a controller 304 of the measurement information system 330.

In addition, the output screen 1497 of FIG. 14 shows that the liquid level 393 (in this case, 8 meters) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 1497.

In this case, the testing protocol specifies that 3 measurements are to be taken (e.g., by a user 351 using a manual measurement device), with one measurement to be taken 15 meters from the access point 345 (e.g., hatch) (which is the same as 1 meter from the bottom of the storage tank 340), a second measurement to be taken 12 meters from the access point 345 (which is the same as 4 meters from the bottom of the storage tank 340), and a third measurement to be taken 10 meters from the access point 345 (which is the same as 7 meters from the bottom of the storage tank 340). The output screen 1497 shows some of the formulas used in the model.

The output screen 1597 of FIG. 15 shows that identification information of a storage tank 340 has been obtained (e.g., by a user 351). Specifically, the output screen 1597 shows that identification information in the form of an internal identification number (in this case, 30007) of the storage tank 340 has been obtained, resulting in other associated information about the storage tank 340 (e.g., a height 212 of 16.17 meters) to be retrieved from a table generated and maintained by a controller 304 of the measurement information system 330.

In addition, the output screen 1597 of FIG. 15 shows that the liquid level 393 (in this case, 5 meters) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 1597. In this case, the testing protocol specifies that 2 measurements are to be taken (e.g., by a user 351 using a manual measurement device), with one measurement to be taken 15 meters from the access point 345 (which is the same as 1 meter from the bottom of the storage tank 340), and the other measurement to be taken 12 meters from the access point 345 (which is the same as 4 meters from the bottom of the storage tank 340). The output screen 1597 shows some of the formulas used in the model.

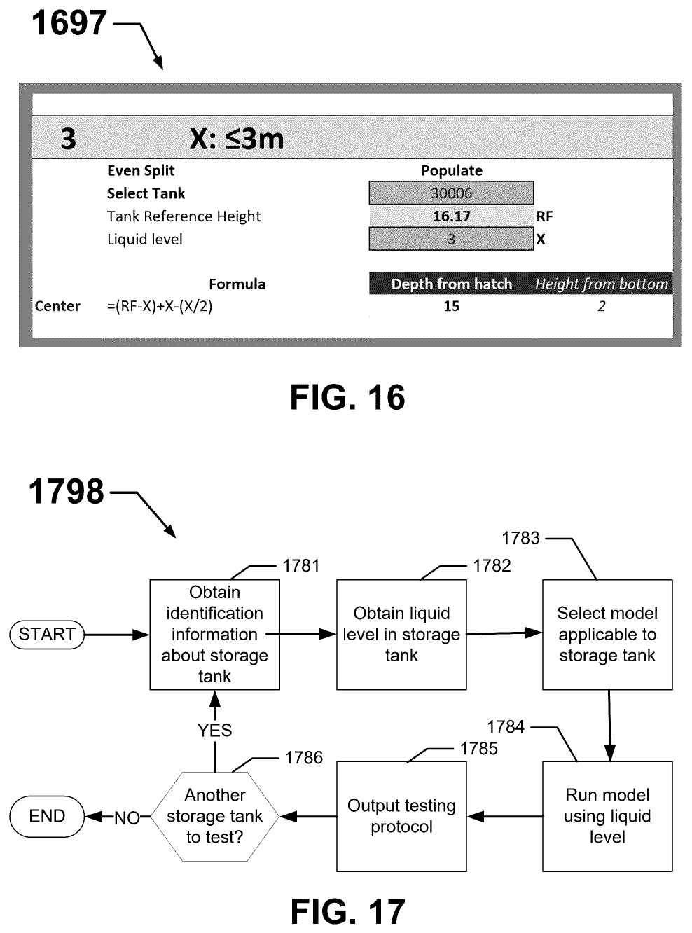

The output screen 1697 of FIG. 16 shows that identification information of a storage tank 340 has been obtained (e.g., by a user 351). Specifically, the output screen 1697 shows that identification information in the form of an internal identification number (in this case, 30007) of the storage tank 340 has been obtained, resulting in other associated information about the storage tank 340 (e.g., a height 212 of 16.17 meters) to be retrieved from a table generated and maintained by a controller 304 of the measurement information system 330.

In addition, the output screen 1697 of FIG. 16 shows that the liquid level 393 (in this case, 3 meters) of the storage tank 340 has been obtained. The liquid level 393 may be obtained from a sensor device 360 obtained by measurement device 357 and/or a user 351. With the identification information of the storage tank 340 and the liquid level 393 of the storage tank 340, a controller 304 of the measurement information system 330 may select a model based on the identification information of the storage tank 340 and run the model using the liquid level 393 obtained by measurement device 357 of the storage tank 340 to generate a testing protocol, as shown in the output screen 1697. In this case, the testing protocol specifies that only one measurement is to be taken (e.g., by a user 351 using a manual measurement device) 15 meters from the access point 345 (which is the same as 2 meters from the bottom of the storage tank 340). The output screen 1697 shows some of the formulas used in the model.

FIG. 17 shows a flowchart 1798 of a method for generating a testing protocol according to certain example embodiments. While the various steps in this flowchart 1798 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order. Some or all of the steps of the method of FIG. 17 may be performed off site (e.g., in an office building remote from a storage tank facility). In addition, or in the alternative, some or all of the steps of the method of FIG. 17 may be performed on site (e.g., in the field, on a tanker) where one or more storage tanks 340 are located.

In addition, a person of ordinary skill in the art will appreciate that additional steps not shown in FIG. 17 may be included in performing this method. Accordingly, the specific arrangement of steps should not be construed as limiting the scope. Further, a particular computing device, such as the computing device 1818 discussed below with respect to FIG. 18, may be used to facilitate (e.g., direct, control, provide instructions, provide recommendations, perform, execute) performance of one or more of the steps for the methods shown in FIG. 17 in certain example embodiments. Any of the functions performed below by a controller 304 may involve the use of one or more protocols, one or more algorithms (e.g., models), and/or stored data stored in a storage repository. In addition, or in the alternative, any of the functions (or portions thereof) in the method may be performed by a user (e.g., user 351).

The method shown in FIG. 17 is merely an example that may be performed by using an example system described herein. In other words, systems for generating a testing protocol may perform other functions using other methods in addition to and/or aside from those described with respect to FIG. 17. Referring to the description above with respect to FIGS. 1A through 16, the method shown in the flowchart 1798 of FIG. 17 begins at the START step and proceeds to step 1781, where identification information about the storage tank 340 is obtained. The identification information may be obtained by a controller 304 of the example measurement information system 330. The identification information may be obtained from one or more users 351 (including any associated user systems 355), from one or more sensor devices 360, from the network manager 380, and/or from any other source of information in the system 300. The identification information may be obtained using one or more communication links 305.

In step 1782, a liquid level 393 in the storage tank 340 is obtained. The liquid level 393 in the storage tank 340 may be obtained by a controller 304 of the example measurement information system 330. The liquid level 393 in the storage tank 340 may be obtained from one or more users 351 (including any associated user systems 355), from one or more sensor devices 360, from the network manager 380, and/or from any other source of information in the system 300. The liquid level 393 may be obtained using one or more communication links 305. In step 1783, a model applicable to the storage tank 340 is selected. The model may be selected from among multiple models by a controller 304 of the example measurement information system 330. The controller 304 may select the model based, at least in part, on the identification information about the storage tank 340 and its UOM

In step 1784, the model is run using the liquid level 393. The model may be run by a controller 304 of the example measurement information system 330. When the model is run, the model generates a testing protocol (e.g., the total number of measurements required, the depth (e.g., in the liquid 394, in the storage tank 340) at which each measurement is to be taken). In step 1785, the testing protocol is output. The testing protocol may be output by a controller 304 of the example measurement information system 330. The testing protocol may be output to one or more users 351 (including any associated user systems 355) and/or the network manager 380. The testing protocol may be output in any format and/or using any medium that is suitable for the recipient. The testing protocol may be output using one or more communication links 305.

In step 1786, a determination is made as to whether there is another storage tank that needs to be tested. Such a determination may be made by a controller 304 of the example measurement information system 330, one or more users 351 (including any associated user systems 355), one or more sensor devices 360, the network manager 380, and/or any component of the system 300. If there is another storage tank 340 to test, the process reverts to step 1781. If there is not another storage tank 340 to test, the process proceeds to the END step.

FIG. 18 shows a block diagram of a computing device 418 according to certain example embodiments. Specifically, FIG. 18 illustrates one embodiment of a computing device 1818 that implements one or more of the various techniques described herein, and which is representative, in whole or in part, of the elements described herein pursuant to certain example embodiments. For example, a controller 304 (including components thereof, such as a control engine, a hardware processor, a storage repository, a power module, and a transceiver) may be considered a computing device 1818. Computing device 1818 is one example of a computing device and is not intended to suggest any limitation as to scope of use or functionality of the computing device and/or its possible architectures. Neither should the computing device 1818 be interpreted as having any dependency or requirement relating to any one or combination of components illustrated in the example computing device 1818.

The computing device 1818 includes one or more processors or processing units 1814, one or more memory/storage components 1815, one or more input/output (I/O) devices 1816, and a bus 1817 that allows the various components and devices to communicate with one another. The bus 1817 represents one or more of any of several types of bus structures, including a memory bus or memory controller, a peripheral bus, an accelerated graphics port, and a processor or local bus using any of a variety of bus architectures. The bus 1817 includes wired and/or wireless buses.

The memory/storage component 1815 represents one or more computer storage media. The memory/storage component 1815 includes volatile media (such as random access memory (RAM)) and/or nonvolatile media (such as read only memory (ROM), flash memory, optical disks, magnetic disks, and so forth). The memory/storage component 1815 includes fixed media (e.g., RAM, ROM, a fixed hard drive, etc.) as well as removable media (e.g., a Flash memory drive, a removable hard drive, an optical disk, and so forth).

One or more I/O devices 1816 allow a user 351 to enter commands and information to the computing device 1818, and also allow information to be presented to the user 351 and/or other components or devices. Examples of input devices 1816 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques is stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 1818 (also sometimes called a computer system herein) is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer device 1818 includes at least the minimal processing, input, and/or output means necessary to practice one or more embodiments.

Further, those skilled in the art will appreciate that one or more elements of the aforementioned computer device 1818 is located at a remote location and connected to the other elements over a network in certain example embodiments. Further, one or more embodiments are implemented on a distributed system having one or more nodes, where each portion of the implementation (e.g., a controller 304 of the measurement information system 330) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

Example embodiments may be used to automatically provide a testing protocol for a hydrocarbon liquid stored in a storage tank. The testing protocol generated using example embodiments provides a number of samples and/or temperature readings needed to comply with industry standards, regulations, and/or laws, as well as the location (dip point) within the storage tank that each sample and/or temperature reading should be taken. Example embodiments may be used with any unit of measure, any type of storage tank, and any type of hydrocarbon liquid. Example embodiments may provide a number of benefits. Such benefits may include, but are not limited to, ease of use, enhanced product quality, flexibility, configurability, and improved compliance with applicable industry standards and regulations.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A measurement information system comprising:
a controller configured to:
obtain identification information about a storage tank;
obtain a liquid level of a hydrocarbon liquid in the storage tank;
select a model from among a plurality of models associated with the storage tank based on the identification information;
run the model using the liquid level in the storage tank; and
output a testing protocol for the storage tank based on results from running the model, wherein the testing protocol comprises one or more dip points, and wherein the one or more dip points designate one or more locations in the storage tank from which to take one or more temperatures and/or one or more sample measurements of the hydrocarbon liquid.

2. A method for generating a testing protocol, the method comprising:
obtaining identification information about a storage tank;
obtaining a liquid level of a hydrocarbon liquid in the storage tank;
selecting a model from among a plurality of models associated with the storage tank based on the identification information;
running the model using the liquid level in the storage tank; and
outputting a testing protocol for the storage tank based on results from running the model, wherein the testing protocol comprises one or more dip points, and wherein the one or more dip points designate one or more locations in the storage tank from which to take one or more temperatures and/or one or more sample measurements of the hydrocarbon liquid.
